(19) United States
(12) Patent Application Publication
(10) Pub. No.: US 2009/0150982 A1
(43) Pub. Date: Jun. 11, 2009

(54) APPARATUS AND METHOD FOR DOMAIN MANAGEMENT USING PROXY SIGNATURE

(75) Inventor: Dae Youb KIM, Seoul (KR)

Correspondence Address: DLA PIPER LLP US, P. O. BOX 2758, RESTON, VA, 20195, US

(73) Assignee: SAMSUNG ELECTRONICS CO., LTD., Suwon-si (KR)

(21) Appl. No.: 12/105,826

(22) Filed: Apr. 18, 2008

(30) Foreign Application Priority Data
Dec. 11, 2007 (KR) 10-2007-0128382

(51) Int. Cl. H04L 9/32; G06F 21/24

(52) U.S. Cl. 726/5; 726/29

(57) ABSTRACT

A domain management apparatus and method using a proxy signature is provided. A domain management apparatus which manages a device domain being a set of at least one user device, the apparatus including: a registration performing unit for performing a registration procedure for registering the domain management apparatus in a service providing apparatus; a license issuance authority receiving unit for receiving a license issuance authority for content use from the service providing apparatus; and a service providing unit for providing the at least one user device with a content service and a license generated by the license issuance authority.

### CROSS-REFERENCE TO RELATED APPLICATION

This application claims the benefit under 35 U.S.C. §119(a) of a Korean Patent Application No. 10-2007-0128382, filed on Dec. 11, 2007 in the Korean Intellectual Property Office, the entire disclosure of which is hereby incorporated by reference.

### BACKGROUND OF THE INVENTION

1. Field of the Invention

The present invention relates to a domain management apparatus and method which manages a device domain being a set of at least one user device. More particularly, the present invention relates to a domain management apparatus and method by which the domain management apparatus issues a license for a device domain using a proxy signature for the license issuance from a service providing apparatus. The present invention may be applied to a digital data broadcast service.

2. Description of Related Art

Various services for digital contents currently coexist. As the services for the digital contents increase, demands for various service models increase. When providing the services for the digital contents, a domain management model which manages a plurality of devices using the digital contents by setting a domain is applied.

A conventional domain management model is inappropriate for applying a service environment such as an Internet Protocol Television (IPTV) service, the service environment using both a Conditional Access System (CAS) and Digital Right Management (DRM). Specifically, the conventional domain management model may be used for a single DRM system , and the domain and a device included in the domain may be used after being registered in the system.

Also, since the device included in the corresponding domain shares a domain key, there is a problem that the domain key needs to be updated when the device enters the domain or leaves the domain.

Specifically, when interoperating between the CAS and the DRM, as in the IPTV service, domain configuration is difficult, and a DRM system needs to maintain and manage domain change details and key update details.

Accordingly, there is a need for effectively managing a domain including devices.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide a domain management apparatus and method using a proxy signature by which a license issuance authority for a content service is delegated to the domain management apparatus.

An aspect of exemplary embodiments of the present invention also provides a domain management apparatus and method using a proxy signature, which may easily configure a device domain when interoperating between a Conditional Access System (CAS) and Digital Right Management (DRM) by enabling the domain management apparatus to manage change details and a key update history of a user device comprising the device domain.

An aspect of exemplary embodiments of the present invention also provides a domain management apparatus and method using a proxy signature, which may efficiently manage a device domain by enabling the domain management apparatus to perform as a proxy for a proxy signature authority when issuing a license for each of at least one user device.

According to an aspect of exemplary embodiments of the present invention, there is provided a domain management apparatus, the apparatus including: a registration performing unit for performing a registration procedure for registering the domain management apparatus in a service providing apparatus, a license issuance authority receiving unit for receiving a license issuance authority for content use from the service providing apparatus, and a service providing unit for providing the at least one user device with a content service and a license generated by the license issuance authority.

In an exemplary implementation, the license issuance authority receiving unit receives a proxy including proxy signature information of a license issuance from the service providing apparatus, the proxy signature information being the license issuance authority for the content use.

According to an aspect of exemplary embodiments of the present invention, there is provided at least one user device, each including: a registration request unit for requesting the domain management apparatus to register the user device, a service receiving unit for receiving a content service and a license for content use from the domain management apparatus, and a service using unit for using the content service by verifying the received license.

According to an aspect of exemplary embodiments of the present invention, there is provided a domain management method, the method including: performing, using a domain management apparatus, a registration procedure for registering the domain management apparatus in a service providing apparatus; receiving, using the domain management apparatus, a license issuance authority for content use from the service providing apparatus; and providing, using the domain management apparatus, the at least one user device with a content service and a license generated by the license issuance authority.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following detailed description, taken in conjunction with the accompanying drawings in which:

FIG. 1 is a block diagram illustrating a general configuration of a domain management model which manages a device domain using a domain management apparatus according to an exemplary embodiment of the present invention;

FIG. 2 is a block diagram illustrating a configuration of a domain management apparatus according to an exemplary embodiment of the present invention;

FIG. 3 is a block diagram illustrating a configuration of a user device according to an exemplary embodiment of the present invention;

FIG. 4 is a block diagram illustrating a configuration of a content service provided by a domain management apparatus for a user device according to an exemplary embodiment of the present invention;

FIG. 5 is a flowchart illustrating a general process of a domain management method according to an exemplary embodiment of the present invention;

FIG. 6 illustrates a registration process of a domain management apparatus between the domain management apparatus and a service providing apparatus according to an exemplary embodiment of the present invention;

FIG. 7 illustrates a registration process of a user device between a domain management apparatus and the user device according to an exemplary embodiment of the present invention; and

FIG. 8 illustrates a general process for a user device performing a service according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

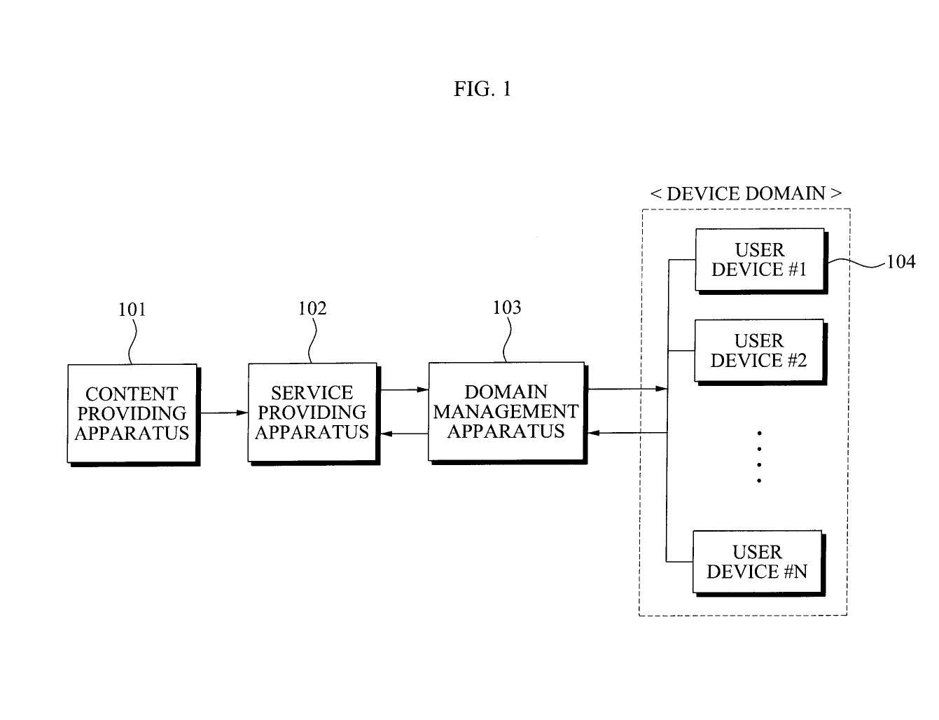

FIG. 1 is a block diagram illustrating a general configuration of a domain management model which manages a device domain using a domain management apparatus according to an exemplary embodiment of the present invention.

The domain management model includes a content providing apparatus 101, a service providing apparatus 102, a domain management apparatus 103, and at least one user device 104 comprising a device domain.

The content providing apparatus 101 may provide the service providing apparatus 102 with contents for a content service.

The service providing apparatus 102 may provide the domain management apparatus 103 with the content service for the contents provided by the content providing apparatus 101. Generally, the service providing apparatus 102 may function as a service provider. Specifically, the service providing apparatus 102 may issue a license using the content service.

According to the present invention, the service providing apparatus 102 may delegate an authority to issue the license to the domain management apparatus 103. Specifically, the service providing apparatus 102 delegates, to the domain management apparatus 103, the authority to sign when issuing the license. The domain management apparatus 103 may manage the device domain being a set of the at least one user device 104.

Specifically, the domain management apparatus 103 may create a signature normally created by the service providing apparatus 102 for a license issuance as a proxy. Accordingly, since the domain management apparatus 103 has the license issuance authority, the domain management apparatus 103 may act as a clearing house for a Digital Right Management (DRM) system.

The domain management apparatus 103 may subsequently provide the content service for the registered user device of the at least one user device 104 included in the device domain. In an exemplary implementation, the domain management apparatus 103 may provide each of the at least one user device 104 with the content service and the license for using the content service. When providing the at least one user device 104 with the license, the domain management apparatus 103 may perform a proxy signature based on the license issuance authority.

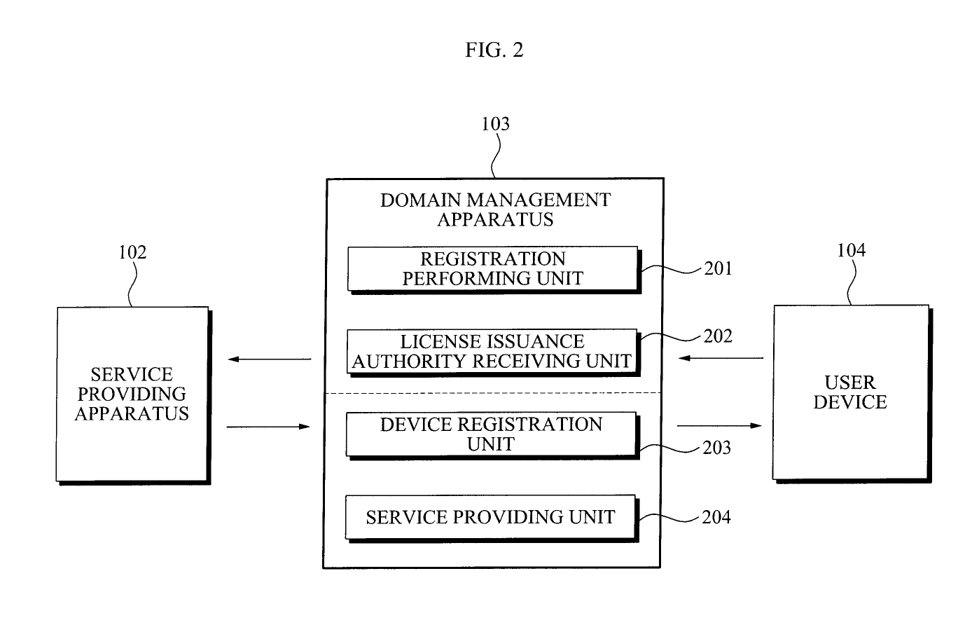

A process during which the license issuance authority is delegated to the domain management apparatus 103 is described in detail with reference to FIG. 2.

FIG. 2 is a block diagram illustrating a configuration of a domain management apparatus according to an exemplary embodiment of the present invention.

In FIG. 2, a service providing apparatus 102, a domain management apparatus 103, and at least one user device 104 may have a certificate for a secret key and a public key for encryption and a signature.

Referring to FIG. 2, the domain management apparatus 103 may include a registration performing unit 201, a license issuance authority receiving unit 202, a device registration unit 203, and a service providing unit 204. As described above, the domain management apparatus 103 may manage a device domain being a set of at least one user device. Different from FIG. 1, FIG. 2 illustrates one user device 104. Descriptions with reference to FIG. 2 are similarly applied to other user devices included in the device domain.

The registration performing unit 201 performs a registration procedure for registering the domain management apparatus 103 in the service providing apparatus 102. The registration performing unit 201 requests the service providing apparatus 102 to register the domain management apparatus 103, using authentication information and registration information of the domain management apparatus 103.

In an exemplary implementation, the authentication information includes a certificate based on a secret key and a public key of the domain management apparatus 103. Also, the registration information includes identification information of the domain management apparatus 103, a certificate, and a condition of the at least one user device 104 comprising the device domain.

The condition of the at least one user device 104 may be changed by a content service. For example, the condition of the at least one user device 104 may include a number of the at least one user device 104 and predetermined identification information of the at least one user device 104.

The license issuance authority receiving unit 202 may receive a license issuance authority for content use from the service providing apparatus 102. For example, the license issuance authority receiving unit 202 receives a proxy including proxy signature information of a license issuance from the service providing apparatus 102, the proxy signature information being a license issuance authority for the content use.

For example, a process during which a proxy signature is delegated from the service providing apparatus 102 to the domain management apparatus 103 is summarized as follows.

(1) A step of generating the public key and a parameter

(2) A step of preparing for the proxy signature

The service providing apparatus 102 being an original signer has a private key (p₀, q₀, d₀) and a public key (N₀, e₀). Also, the domain management apparatus 103 being a proxy signer has a private key (p₁, q₁, d₁) and a public key (N₁, e₁). Also, a hash function of the service providing apparatus 102 is H₀, and the hash function of the domain management apparatus 103 is H₁.

(3) A process of delegating the proxy signature

The service providing apparatus 102 generates a proxy mᵤ including information of the proxy signature, such as an authority limit and a valid period, and makes the proxy mᵤ public in the domain management apparatus 103. The service providing apparatus 102 signs the proxy mᵤ by a proxy signature key S₀ in accordance with Equation 1 as follows, and provides the signed proxy mᵤ for the domain management apparatus 103.

S₀=H₀(mᵤ)^{d}^{₀} mod N₀. [Equation 1]

In an exemplary implementation, the domain management apparatus 103 may verify a signature, and when the signature is valid, the domain management apparatus 103 may use S₀ as a proxy key.

Hereinafter, a configuration in which the domain management apparatus 103 having a proxy signature authority for the license issuance provides the content service and a generated license for each of the at least one user device 104 included in the device domain is described.

The device registration unit 203 registers the at least one user device 104 by using device information of each of the at least one user device 104. In an exemplary implementation, the device registration unit 203 registers the at least one user device 104 by verifying a registration request including authentication information and registration information of the at least one user device 104.

The service providing unit 204 provides the at least one user device 104 with the content service and the license generated by the license issuance authority. In an exemplary implementation, the service providing unit 204 provides the license by generating the license for each of the at least one user device 104 comprising the device domain based on the license issuance authority.

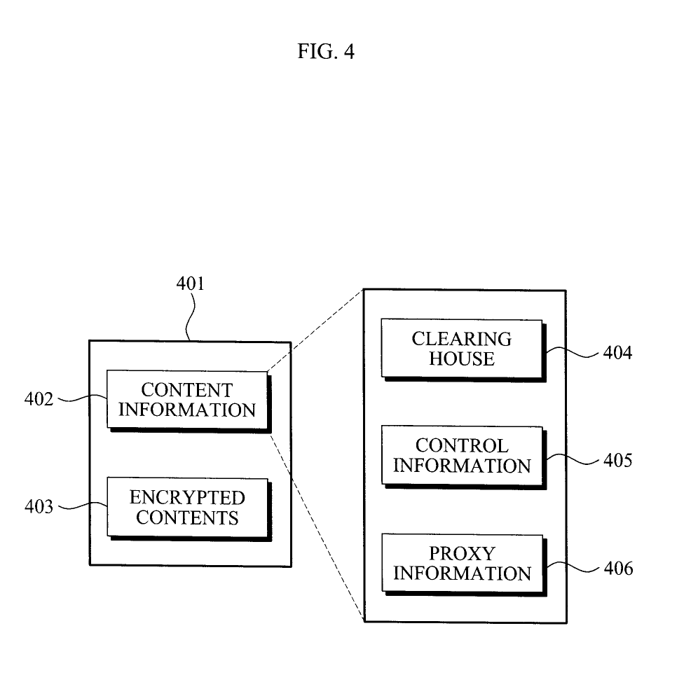

Also, the service providing unit 204 provides the at least one user device 104 with the content service including encrypted contents and content information including proxy information for a license issuance. Here, the content service is described in detail with reference to FIG. 4.

For example, a process during which the domain management apparatus 103 performs the proxy signature for the license generated in the at least one user device 104, and a verification process for the proxy signature so that the at least one user device 104 may use the content service are described as follows.

(1) A proxy signature process

In order to perform the proxy signature for the license, the domain management apparatus 103 selects a random number r and performs a calculation in accordance with Equation 2:

R=r^{e}^{ₒ} mod N₀

r₁=s₀×r mod N

r₂=Hₚ(m, R)^{dP} mod N^{P}, [Equation 2]

where r₁ and r₂ denote proxy signatures for a license.

(2) A proxy signature verification process

When the at least one user device 104 receives, from the domain management apparatus 103, the license for which the proxy signature is performed, a proxy signature verification is performed for determining whether content service use is permitted. In an exemplary implementation, the proxy signature verification is performed using Equation 3:

R′=(r₁)^{e}^{₀}×H₀(mᵤ)⁻¹

(r₂)^{ep}=Hₚ(m,R′), [Equation 3]

where a top equation of Equation 3 is an equation of calculating mod N₀, and a bottom equation of Equation 3 is an equation of identifying mod N^{p}.

Accordingly, the domain management apparatus 103 may be registered in the service providing apparatus 102 and the proxy signature authority for the license issuance may be delegated to the domain management apparatus 103. Also, the domain management apparatus 103 may provide the at least one user device 104 with the content service and the license for which the proxy signature is performed. Specifically, according to the present invention, the service providing apparatus 102 does not directly provide the at least one user device 104 with the content service and the license for using the service, and the domain management apparatus 103 to which an authority is delegated provides the content service and the license.

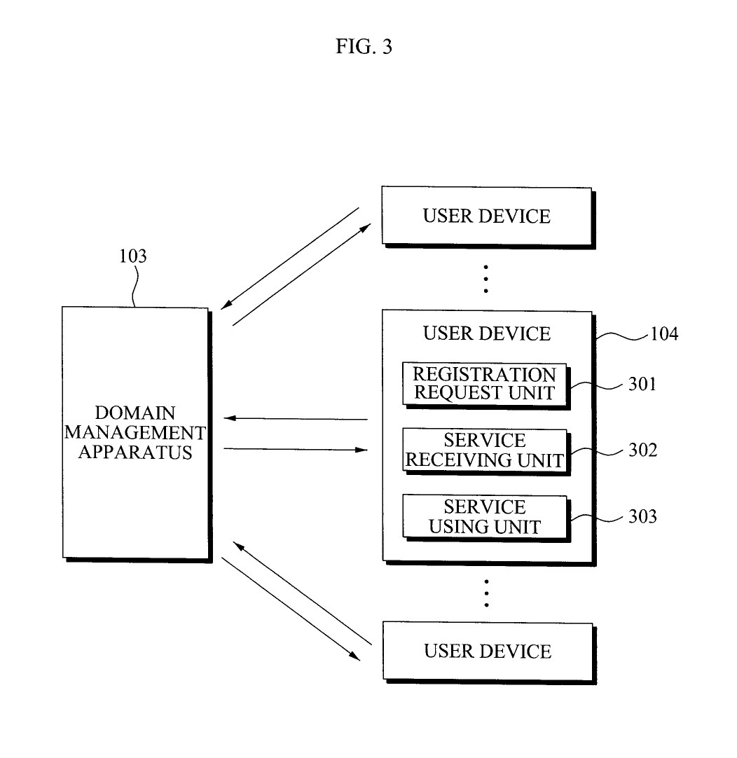

FIG. 3 is a block diagram illustrating a configuration of a user device 104 according to an exemplary embodiment of the present invention.

Referring to FIG. 3, the user device 104 includes a registration request unit 301, a service receiving unit 302, and a service using unit 303. A description with reference to FIG. 3 is similarly applied to each of at least one user device comprising a device domain.

The registration request unit 301 requests a domain management apparatus 103 to register the user device 104. For example, the registration request unit 301 requests the domain management apparatus 103 to register the user device 104, using authentication information and registration information of the user device 104.

In an exemplary implementation, the authentication information includes a certificate based on a secret key and a public key of the user device 104, and the registration information includes identification information of the user device 104 and a certificate.

The domain management apparatus 103 subsequently verifies the authentication information included in a registration request of the registration request unit 301, and when the verification succeeds, the domain management apparatus 103 stores device information of the user device 104 and performs a registration. The domain management apparatus 103 may transmit, to the user device 104, a message that the registration succeeds.

For example, a process of registering the user device 104 in the domain management apparatus 103 may be performed before the domain management apparatus 103 is registered in the service proving apparatus 102.

The service receiving unit 302 may receive a content service and a license for content use from the domain management apparatus 103. In an exemplary implementation, the service receiving unit 302 receives, from the domain management apparatus 103, the content service including encrypted contents and content information including proxy information for a license issuance.

Also, the service receiving unit 302 receives, from the domain management apparatus 103, the content service and the license generated by a proxy signature for the license issuance.

The service using unit 303 uses the content service by verifying the license received from the domain management apparatus 103. In an exemplary implementation, the service using unit 303 verifies, using a proxy signature included in the license, whether the domain management apparatus 103 has an authority for the license issuance. For example, a process of verifying the proxy signature may be performed by the above-described Equation 3.

FIG. 4 is a block diagram illustrating a configuration of a content service 401 provided by a domain management apparatus for a user device according to an exemplary embodiment of the present invention.

Specifically, FIG. 4 illustrates a configuration of the content service 401 provided by the domain management apparatus 103 for each of the at least one user device 104 comprising the device domain again, the content service being provided by the service providing apparatus 102.

The content service 401 may include content information 402 for the content service and encrypted contents 403 encrypted using an encryption key. Also, content information 402 according to the present invention may further include a clearing house 404, control information 405, and proxy information 406.

The clearing house 404 may include a policy for a user item and a device item for each content. Specifically, the clearing house 404 may perform a function of limiting use of the contents by the user device in the device domain.

The content information 402 includes information related to the contents and a license issuance for the contents, information about whether the domain management apparatus 103 may issue a license, and an issuance condition. In particular, the proxy information 406 may include an authority by which the domain management apparatus 103 may issue a license as a proxy of the service providing apparatus 102, and issuance restrictions.

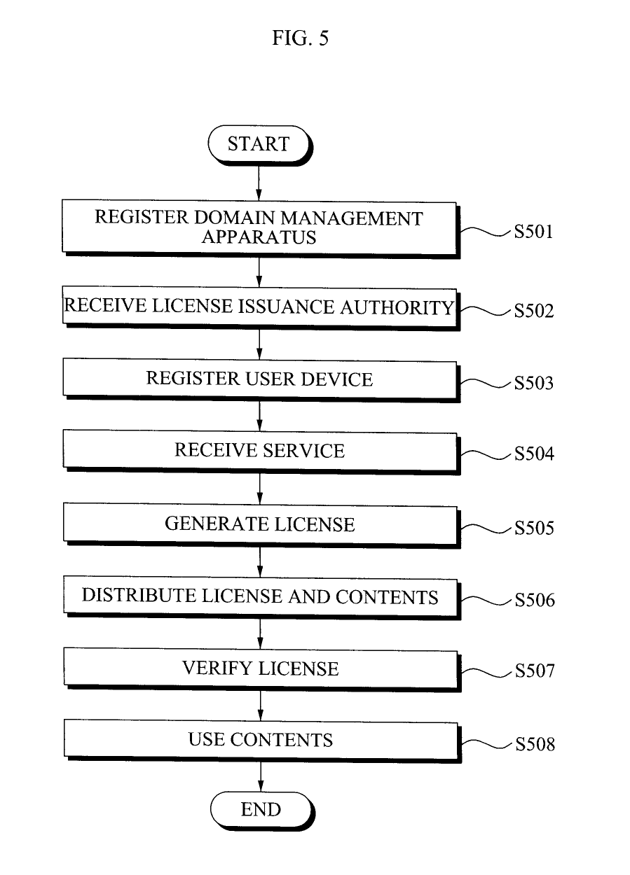

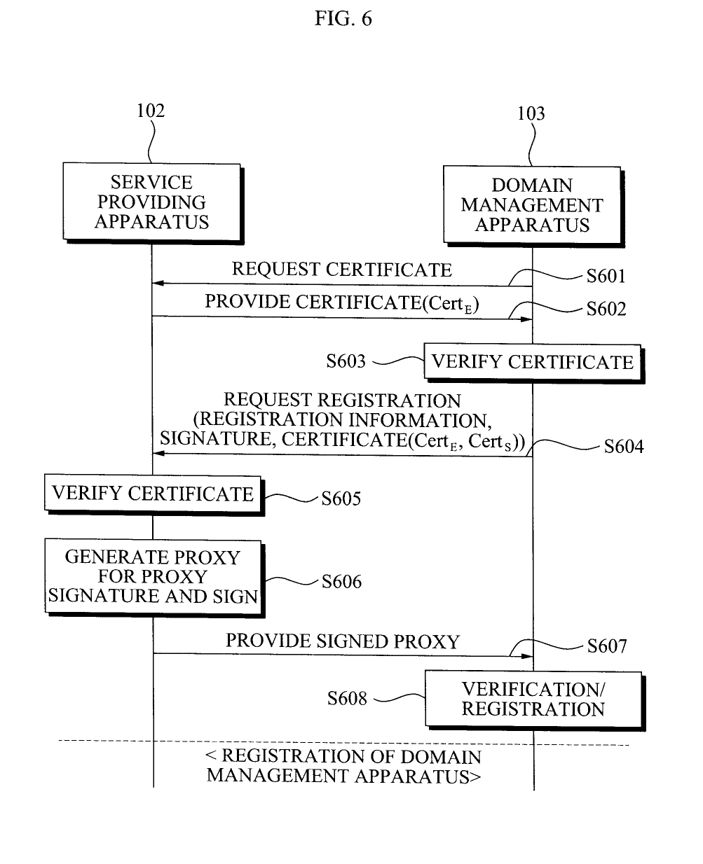

FIG. 5 is a flowchart illustrating a general process of a domain management method according to an exemplary embodiment of the present invention. Contents of FIG. 5 are described in detail with reference to FIGS. 6 through 8.

According to the present exemplary embodiment of the present invention, in step S501, the domain management apparatus 103 may register the domain management apparatus 103 in a service providing apparatus 102. In an exemplary implementation, the domain management apparatus 103 may perform a registration procedure for registering the domain management apparatus 103 in the service providing apparatus 102.

In an exemplary implementation, in step S501, the domain management apparatus 103 requests the service providing apparatus 102 to register the domain management apparatus 103, using authentication information and registration information of the domain management apparatus 103.

In an exemplary implementation, the authentication information includes a certificate based on a secret key and a public key of the domain management apparatus 103, and the registration information includes identification information of the domain management apparatus 103, a certificate, and a condition of the at least one user device 104 comprising the device domain.

According to the present exemplary embodiment of the present invention, in step S502, the domain management apparatus 103 receives a license issuance authority for content use from the service providing apparatus 102.

In step S502, the domain management apparatus 103 receives a proxy including proxy signature information of a license issuance from the service providing apparatus 102, the proxy signature information being a license issuance authority for the content use.

According to the present exemplary embodiment of the present invention, in step S503, the domain management apparatus 103 registers the at least one user device 104 by using device information of each of the at least one user device 104.

In step S503, the domain management apparatus 103 registers the at least one user device 104 by verifying a registration request including authentication information and registration information of the at least one user device 104.

According to the present exemplary embodiment of the present invention, in step S504, the domain management apparatus 103 receives the content service provided by the service providing apparatus 102.

According to the present exemplary embodiment of the present invention, in step S505, the domain management apparatus 103 generates a license generated by a license issuance authority. In an exemplary implementation, in step S505, the domain management apparatus 103 generates the license for each of the at least one user device 104 comprising the device domain based on the license issuance authority.

According to the present exemplary embodiment of the present invention, in step S506, the domain management apparatus 103 distributes the license and the content service to provide the at least one user device 104 with the generated license and the content service received from the service providing apparatus 102.

In an exemplary implementation, in step S506, the domain management apparatus 103 provides the at least one user device 104 with the content service including encrypted contents and content information including proxy information for a license issuance.

According to the present exemplary embodiment of the present invention, in step S507, each of the at least one user device 104 verifies the license provided by the domain management apparatus 103. In step S508, after the license is verified, each of the at least one user device 104 may use the content service.

In an exemplary implementation, in step S507, the at least one user device 104 verifies, using a proxy signature included in the license, whether the domain management apparatus 103 has an authority for the license issuance.

FIG. 6 illustrates a registration process of the domain management apparatus 103 between the domain management apparatus 103 and a service providing apparatus 102 according to an exemplary embodiment of the present invention.

In step S601, the domain management apparatus 103 requests the service providing apparatus 102 for a certificate. In step S602, the service providing apparatus 102 subsequently provides the domain management apparatus 103 with a certificate Cert_{E} based on a public key.

In step S603, the domain management apparatus 103 verifies the provided certificate. In step S604, when the verification succeeds, the domain management apparatus 103 requests the service providing apparatus 102 to register the domain management apparatus 103 using registration information of the domain management apparatus 103, a signature, and certificates Cert_{E} and Certₛ based on the public key and a secret key of the domain management apparatus 103.

In step S605, the service providing apparatus 102 verifies the certificates Cert_{E} and Certₛ based on the public key and the secret key of the domain management apparatus 103. In step S606, when the verification for the certificates is completed, the service providing apparatus 102 generates a proxy for a proxy signature and signs the proxy.

In step S607, the service providing apparatus 102 provides the signed proxy for the domain management apparatus 103. The proxy of the proxy signature denotes an authority by which the domain management apparatus 103 may sign for a license issuance necessary for using the content service as a proxy of the service providing apparatus 102.

In step S608, the domain management apparatus 103 subsequently verifies the signature included in the proxy, and when the verification is completed, the domain management apparatus 103 is registered in the service providing apparatus 102.

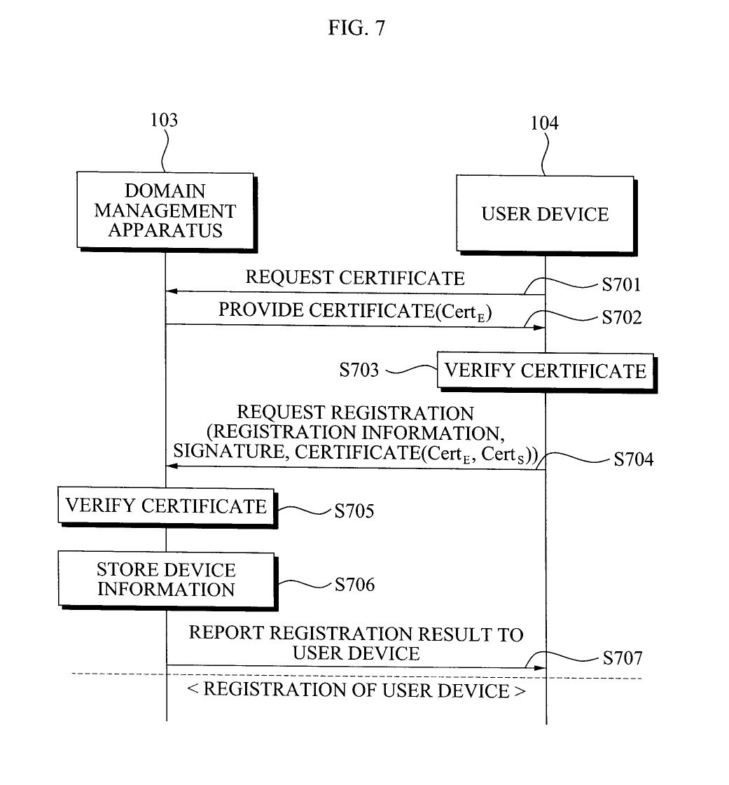

FIG. 7 illustrates a registration process of the user device 104 between the domain management apparatus 103 and the user device 104 according to an exemplary embodiment of the present invention.

In step S701, the user device 104 requests the domain management apparatus 103 for a certificate. In step S702, the domain management apparatus 103 provides a certificate Cert_{E} based on a secret key for the user device 104. In step S703, the user device 104 verifies the provided certificate.

In step S704, the user device 104 requests the domain management apparatus 103 to register the user device 104 using registration information of the user device 104, a signature, and certificates Cert_{E} and Certₛ based on the public key and a secret key of the user device 104.

In step S705, the domain management apparatus 103 subsequently verifies the certificates Cert_{E} and Certₛ. In step S706, when the verification is completed, the domain management apparatus 103 stores device information of the user device 104. In step S707, the domain management apparatus 103 reports a registration result to the user device 104.

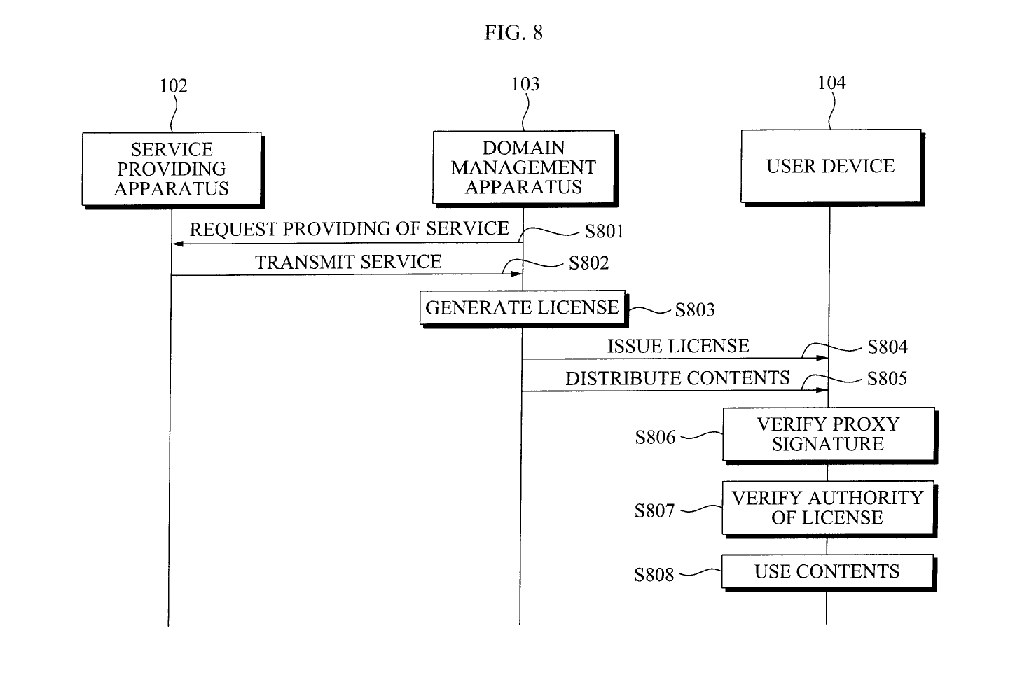

FIG. 8 illustrates a general process for a user device 104 performing a service according to an exemplary embodiment of the present invention.

FIG. 8 assumes that the domain management apparatus 103 is registered in the service providing apparatus 102, and the user device 104 is registered in the domain management apparatus 103. In step S801, the domain management apparatus 103 requests the service providing apparatus 102 to provide a service. In step S802, the service providing apparatus 102 transmits the service to the domain management apparatus 103.

In step S803, the domain management apparatus 103 having received the service generates a license using a license issuance authority delegated from the service providing apparatus 102. In step S804, the domain management apparatus 103 issues the generated license to the user device 104. Also, in step S805, the domain management apparatus 103 distributes contents to the user device 104 by providing the content service received from the service providing apparatus 102.

In step S806, the user device 104 verifies a proxy signature included in the issued license. In step S807, the user device 104 verifies whether the domain management apparatus 103 has authority for a license issuance. In step S808, when the verification process is completed, the user device 104 uses the contents based on the content service.

The domain management method using the proxy signature according to the above-described exemplary embodiments of the present invention may be recorded in computer-readable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

While the invention has shown and described with reference to certain exemplary embodiments thereof, it will be understood by those skilled in the art that various changes in form and details may be made therein without departing from the spirit and scope of the present invention as defined by the appended claims and their equivalents.

What is claimed is:

1. A domain management apparatus which manages a device domain being a set of at least one user device, the apparatus comprising:
a registration performing unit for performing a registration procedure for registering the domain management apparatus in a service providing apparatus;
a license issuance authority receiving unit for receiving a license issuance authority for content use from the service providing apparatus; and
a service providing unit for providing the at least one user device with a content service and a license generated by the license issuance authority.

2. The apparatus of claim 1, wherein the registration performing unit requests the service providing apparatus to register the domain management apparatus, using authentication information and registration information of the domain management apparatus.

3. The apparatus of claim 2, wherein the authentication information includes a certificate based on a secret key and a public key of the domain management apparatus, and
the registration information includes identification information of the domain management apparatus, a certificate, and a condition of the at least one user device comprising the device domain.

4. The apparatus of claim 1, wherein the license issuance authority receiving unit receives a proxy including proxy signature information of a license issuance from the service providing apparatus, the proxy signature information being the license issuance authority for the content use.

5. The apparatus of claim 1, further comprising:
a device registration unit for registering the at least one user device by using device information of each of the at least one user device.

6. The apparatus of claim 5, wherein the device registration unit registers the at least one user device by verifying a registration request including authentication information and registration information of the at least one user device.

7. The apparatus of claim 1, wherein the service providing unit provides the license by generating the license for each of the at least one user device comprising the device domain based on the license issuance authority.

8. The apparatus of claim 1, wherein the service providing unit provides the at least one user device with the content service including encrypted contents and content information including proxy information for a license issuance.

9. At least one user device comprising a device domain managed by a domain management apparatus, each of the at least one user device comprising:
a registration request unit for requesting the domain management apparatus to register the user device;
a service receiving unit for receiving a content service and a license for content use from the domain management apparatus; and
a service using unit for using the content service by verifying the received license.

10. The user device of claim 9, wherein the registration request unit requests the domain management apparatus to register the user device, using authentication information and registration information of the user device.

11. The user device of claim 10, wherein the authentication information includes a certificate based on a secret key and a public key of the user device, and
the registration information includes identification information of the user device and a certificate.

12. The user device of claim 9, wherein the service receiving unit receives, from the domain management apparatus, the content service including encrypted contents and content information including proxy information for a license issuance.

13. The user device of claim 9, wherein the service receiving unit receives, from the domain management apparatus, the content service and the license generated by a proxy signature for a license issuance.

14. The user device of claim 9, wherein the service using unit verifies, using a proxy signature included in the license, whether the domain management apparatus has an authority for a license issuance.

15. A domain management method which manages a device domain being a set of at least one user device, the method comprising:
performing, using a domain management apparatus, a registration procedure for registering the domain management apparatus in a service providing apparatus;
receiving, using the domain management apparatus, a license issuance authority for content use from the service providing apparatus; and
providing, using the domain management apparatus, the at least one user device with a content service and a license generated by the license issuance authority.

16. The method of claim 15, wherein the performing requests the service providing apparatus to register the domain management apparatus, using authentication information and registration information of the domain management apparatus.

17. The method of claim 16, wherein the authentication information includes a certificate based on a secret key and a public key of the domain management apparatus, and
the registration information includes identification information of the domain management apparatus, a certificate, and a condition of the at least one user device comprising the device domain.

18. The method of claim 15, wherein the receiving receives, using the domain management apparatus, a proxy including proxy signature information of a license issuance from the service providing apparatus, the proxy signature information being a license issuance authority for the content use.

19. The method of claim 15, further comprising:
registering, using the domain management apparatus, the at least one user device by using device information of each of the at least one user device.

20. The method of claim 19, wherein the registering registers, using the domain management apparatus, the at least one user device by verifying a registration request including authentication information and registration information of the at least one user device.

21. The method of claim 15, wherein the providing provides, using the domain management apparatus, the license by generating the license for each of the at least one user device comprising the device domain based on the license issuance authority.

22. The method of claim 15, wherein the providing provides, using the domain management apparatus, the at least one user device with the content service including encrypted contents and content information including proxy information for a license issuance.

23. A computer-readable recording medium storing a program for implementing a domain management method which manages a device domain being a set of at least one user device, the method comprising:
performing, using a domain management apparatus, a registration procedure for registering the domain management apparatus in a service providing apparatus;
receiving, using the domain management apparatus, a license issuance authority for content use from the service providing apparatus; and
providing, using the domain management apparatus, the at least one user device with a content service and a license generated by the license issuance authority.
